(19) United States
(12) Patent Application Publication
(10) Pub. No.: US 2022/0010532 A1
(43) Pub. Date: Jan. 13, 2022

(54) Landfill Precious Metals Mining

(71) Applicant: Sean DeVier Ensley, BRUNSWICK, MD (US)

(72) Inventor: Sean DeVier Ensley, BRUNSWICK, MD (US)

(21) Appl. No.: 16/946,942

(22) Filed: Jul. 13, 2020

(51) Int. Cl. E02F 9/26; B09B 3/00; C22B 11/00; E02F 3/34

(52) U.S. Cl. CPC E02F 9/261; E02F 3/3417; C22B 11/00; B09B 3/00

(57) ABSTRACT

The process and practice of extracting and/or removing precious metals and/or other elements from landfills or other environments designated for the processing, storing, and final disposal of municipal solid or construction waste. This process applies to all landfill operations, when the intent is to recover precious metals (e.g. Gold, Silver, Platinum, Palladium, Rhodium, etc.) or other valuable soil materials (due to decades or centuries of decomposing trash), and includes the inadvertent discovery of such materials during land reclamation or remediation activities that require the use of earth moving equipment/machinery such as excavators, front end loaders, etc.

### ASSUMPTIONS

My assumptions are:

(a) the anticipated improvement of the technologies for detecting, sorting, and recovering precious metals and other valuable materials from landfills.

(b) the increasing interest and need for reducing greenhouse gas emissions, worldwide.

(c) the increasing need and interest for improving inadequate diversion of reusable and recoverable municipal solid waste (MSW) materials.

(d) there is a finite amount of precious metals in the world. Due to consumption and the industrial application of some precious metals (i.e. silver), traditional mining, and therefore inventories, will inevitably decline. The demand for metals discarded as MSW will become economically viable.

### SUMMARY OF THE IDEA

This idea relates to the processes and practices of extracting and/or removing, from landfills or any other environments designated for the processing, storing, and disposal of municipal solid waste, precious metals including but not limited to gold (Au), silver (Ag), Platinum (Pt), Palladium (Pd), Rhodium (Rh), etc.

Precious metals are generally defined as rare, naturally occurring, metallic chemical elements that are of high economic value. Gold, silver, platinum, palladium, and rhodium (identified on the Periodic Table of the Elements as atomic numbers 79, 47, 78, 46, and 45, respectively) are a few examples.

This idea applies to all landfill mining or similar operations, public and private, when the intent is to recover precious metals or other valuable soil elements due to decades or centuries of decomposing trash, and includes the inadvertent discovery or of such materials during land reclamation or remediation activities that require the use of earth moving equipment/machinery such as excavators, front end loaders, etc. In other words, any process or activity that excavates and processes solid waste and soil materials which have previously been landfilled or stored as the final disposal point.

1. The process of extracting precious metals from landfills and other environments designated for the processing, storing, and disposal of municipal solid waste or construction materials, which comprise the steps of:
(a) using information and/or technology of any kind to detect the presence of precious metals or other valuable materials from any landfill environment or facility that process waste materials;
(b) using any type of earth moving equipment or machinery such as excavators, front end loaders, etc., to gain access to the precious metals or other valuable materials at any municipal or private solid waste location;
(c) recovering precious metals, including but not limited to gold (Au), silver (Ag), Platinum (Pt), Palladium (Pd), Rhodium (Rh), etc., and any other valuable materials;
(d) processing, refining, or improving the condition of any recovered materials, in any way, for the purpose of reintroduction into any market for resale or collection.
